(19) United States
(12) Patent Application Publication
(10) Pub. No.: US 2025/0242232 A1
(43) Pub. Date: Jul. 31, 2025

(54) SYSTEMS AND METHODS FOR ELECTRONIC GAME CONTROL AND GAME CONTROLLER CONFIGURATIONS WITH EMG SENSING

(71) Applicant: Sony Interactive Entertainment Inc., Tokyo (JP)

(72) Inventor: Jeffrey Stafford, Redwood City, CA (US)

(73) Assignee: Sony Interactive Entertainment Inc., Tokyo (JP)

(21) Appl. No.: 18/422,288

(22) Filed: Jan. 25, 2024

(51) Int. Cl. A63F 13/212; A63F 13/24; G06F 3/01

(52) U.S. Cl. CPC A63F 13/212; A63F 13/24; G06F 3/015

(57) ABSTRACT

Systems, processes and device configurations are provided for electronic game control with electromyography (EMG) sensing. Embodiments include processes for receiving EMG sensor output and detection of EMG user controls, such as user electrical activity in connection with movement of fingers and hands, and output of user EMG control signals for control of electronic game content. EMG signals may be detected by a one or more sensors on a wrist strap to detect user signals and secure user controllers. Embodiments include game controller configurations and systems for electronic game content presentation. Game controller configurations may include at least one of an interface for receiving EMG data and for powering EMG sensors. System configurations may include processing EMG signals and user activation signals of a game controller to reduce latency of generated game content. Machine learning models are described for training and use to identify user control signals from the EMG signal.

### FIELD

The present disclosure is directed to systems and methods for electronic game control and game controller configurations, including electromyography (EMG) sensing of users to reduce latency of gaming system operation, processing of game input controls and machine learning operations for characterizing EMG signals.

### BACKGROUND

Computer and console games often receive input from control devices to receive user controls. As device processing increases and game environments become more immersive, there is a desire for enhancement of content and customization of game interaction with users. For some gaming services, especially network or streaming games, latency in user controls and game data processing is very noticeable to users. By way of example, gaming operations and controls that are local to a user may not be visible to other networked users due to game delay. For applications with high data throughput, game controls may stall or slow the presentation of content for a user. For at least these reasons there is a need for improving device performance to improve gaming data performance. In addition, there also exists a desire to improve game control features for gaming and interactive systems where traditional hand controls may be limited in providing control features.

### BRIEF SUMMARY OF THE EMBODIMENTS

Disclosed and described herein are systems, methods and configurations for game control with electromyography (EMG) sensing. In one embodiment, a method includes receiving, by a device, output of at least one electromyography (EMG) sensor for a user of an electronic game, the output including at least one EMG signal for the user. The method includes detecting, by the device, an EMG user control signal in the at least one EMG signal for the user, and outputting, by the device, the EMG user control signal for control of electronic game presentation.

In one embodiment, the output of the at least one EMG sensor includes electrical activity detected from a user wrist and associated with at least one of a hand movement and finger movement of a user.

In one embodiment, the output of the at least one EMG sensor includes electrical activity associated with user EMG data for at least one of a button press, directional pad input, analog stick motion, finger gesture, wrist motion, and controller movement.

In one embodiment, detecting a user control signal includes correlating at least a portion of the EMG signal to recorded EMG data for a user game controller action.

In one embodiment, the method includes detecting user activation of the game controller after detecting the EMG user control signal and generating controller output based on the user activation, and wherein outputting the user control signal includes output of the user control signal to a game controller prior to generating the controller output based on the user activation.

According to another embodiment, a game controller is provided. The game controller includes a strap including at least one electromyography (EMG) sensor, and a game controller body supporting at least one input control. The game controller includes a controller housed in the game controller body electrically coupled to the at least one input control, wherein the controller is configured to receive output of at least one electromyography (EMG) sensor for a user of an electronic game, the output including at least one EMG signal for the user. The controller is configured to detect an EMG user control signal in the at least one EMG signal for the user and output the EMG user control signal for control of electronic game presentation.

In one embodiment, the at least one EMG sensor includes a plurality of EMG sensor elements retained by the strap, wherein the strap is coupled to the game controller body and configured to secure the game controller to the user, and wherein the strap includes at least one electrical connection for each of the EMG sensor elements and an interface of the game controller body.

In one embodiment, the output of the at least one EMG sensor includes electrical activity detected from a user wrist and associated with at least one of a hand movement and finger movement of a user.

In one embodiment, the output of the at least one EMG sensor includes electrical activity associated with user EMG data for at least one of a button press, directional pad input, analog stick motion, finger gesture, wrist motion, and controller movement.

In one embodiment, detecting a user control signal includes correlating at least a portion of the EMG signal to recorded EMG data for a user game controller action.

In one embodiment, detecting a user control signal includes using a machine learning model to detect and identify the user control signal from the EMG signal.

In one embodiment, the controller is further configured to detect user activation of the game controller after detecting the EMG user control signal and generating controller output based on the user activation, and wherein outputting the user control signal includes output of the user control signal to a game controller prior to generating the controller output based on the user activation.

According to another embodiment, a system is provided, the system including a gaming device and a game controller. The game controller includes a strap including at least one electromyography (EMG) sensor, and a game controller body supporting at least one input control. The game controller includes a controller housed in the game controller body electrically coupled to the at least one input control, wherein the controller is configured to receive output of at least one electromyography (EMG) sensor for a user of an electronic game, the output including at least one EMG signal for the user. The controller is further configured to detect an EMG user control signal in the at least one EMG signal for the user, and output the EMG user control signal for control of electronic game presentation to the gaming device.

In one embodiment, the at least one EMG sensor includes a plurality of EMG sensor elements retained by the strap, wherein the strap is coupled to the game controller body and configured to secure the game controller to the user, and wherein the strap includes at least one electrical connection for each of the EMG sensor elements and an interface of the game controller body.

In one embodiment, the output of the at least one EMG sensor includes electrical activity detected from a user wrist and associated with at least one of a hand movement and finger movement of a user.

In one embodiment, the output of the at least one EMG sensor includes electrical activity associated with user EMG data for at least one of a button press, directional pad input, analog stick motion, finger gesture, wrist motion, and controller movement.

In one embodiment, detecting a user control signal includes correlating at least a portion of the EMG signal to recorded EMG data for a user game controller action.

In one embodiment, detecting a user control signal includes using a machine learning model to detect and identify the user control signal from the EMG signal.

In one embodiment, the controller is further configured to detecting user activation of the game controller after detecting the EMG user control signal and generating controller output based on the user activation, and wherein outputting the user control signal includes output of the user control signal to a game controller prior to generating the controller output based on the user activation.

In one embodiment, the gaming device is configured to control presentation of electronic game data, and wherein the gaming device is configured to generate game data for a first game state based on the user control signal detected in the at least one EMG signal for the user, and wherein the gaming device is configured to generate game data for a second game state in response to the user control signal and expiration of a user controller activation window.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1A is a graphical representation of a system for electronic game control with electromyography (EMG) sensing according to one or more embodiments;

FIG. 1B is a graphical representation of a controller configuration with an EMG sensing wrist strap for electronic game control according to one or more embodiments;

FIG. 2 illustrates a process for electronic game control with EMG sensing according to one or more embodiments;

FIG. 3 illustrates a device configuration according to one or more embodiments;

FIG. 4 is a graphical representation of an EMG signal and controller input in time series according to one or more embodiments;

FIG. 5 is a graphical representation of machine learning operations according to one or more embodiments; and

FIG. 6 illustrates a process for game controller operations according to one or more embodiments.

### DETAILED DESCRIPTION OF THE EXEMPLARY EMBODIMENTS

### Overview and Terminology

One aspect of the disclosure is directed to systems and methods for electronic game control. According to embodiments, electronic game control may include operations for one or more of a gaming console, interactive entertainment device, game controller and one or more network devices for controlling presentation of electronic gaming content. Embodiments are provided for detecting and using one or more electromyography (EMG) sensors and operations to utilize sensor output within gaming device operations. EMG sensors and operations are provided for control interfaces of interactive entertainment devices. While embodiments are discussed herein with respect to control of electronic game content and interactive entertainment, it should be appreciated that the principles of the disclosure are not limited to electronic games and may be applied to other applications. Embodiments may be applied to virtual reality (VR) and augmented reality (AR) systems for gaming and non-gaming applications.

Gaming systems may include consoles or devices that play game media, consoles that provide network data for games, handheld devices, mobile devices (e.g., tablets, mobile phones, etc.) and devices in general configured for electronic gaming. Gaming systems may be applications on mobile devices and tablets. Gaming systems and devices may also receive controls and interact with users by way of control devices, such as game controllers.

Game control may be provided for devices, such as gaming consoles, interactive entertainment devices, displays with control interfaces, handheld gaming units and network devices including gaming servers. Modern gaming applications can provide high quality graphic output and utilize data bandwidths for one or more users. For local and networked gaming operations, there is a desire to reduce latency with respect to detection of user controls and processing of game data. In some instances, such as processing of data for game streaming from a cloud network, latency of inputs may be very noticeable during gameplay. These effects may be especially noticeable for virtual reality (VR) or augmented reality (AR). Embodiments provide configurations and operations to detect and use user EMG signals to reduce latency of operations.

Systems and methods are provided for electronic game control with EMG sensing. EMG signals of a user may be detected and used to identify one or more user EMG signals to user muscles, in the form of electrical activity. By sensing EMG activity, signals may be provided to a game controller, such as one or more of a console, and network device providing gaming content in advance of detection of a button press or user activation on a user controller. By detecting EMG activity, indications of user control may be provided earlier in time and latency of device operation may be reduced. Game control processing may reduce latency for streaming games by providing control signals indicative of user actions in advance of a game controller device receiving user activation of a controller.

Embodiments are directed to configurations for game controllers (e.g., handheld controls, etc.) and control devices. Game controller embodiments include configurations for use and/or interoperation with EMG sensors, EMG sensor and controller connection, and game controller operation. According to embodiments, EMG sensors may be retained and/or provided by a strap or other wearable element to detect user activity. Game controller configurations may provide assistance for interactive entertainment including gaming devices, gaming consoles, virtual reality, and augmented reality systems using controllers.

Systems and methods for electronic game control and game controller configurations with EMG sensing may include operations for controlling signal detection. Embodiments include operations for at least one of training and using machine learning models for detection and identification of user EMG control signals. EMG signals may be used for one or more control inputs of a game controller, including touch sensitive inputs, such as touch pads. Controller configurations may include one or more operations for reconciliation of latency in game controller commands at the controller and by a device controlling presentation of a game. EMG signals may enhance the control of touch pads and may be used to improve the accessibility of control devices.

Although device configurations, systems and processes are discussed with respect to gaming applications and interactive entertainment, it should be appreciated that the principles of the disclosure may be applied to network control devices and input devices in general.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

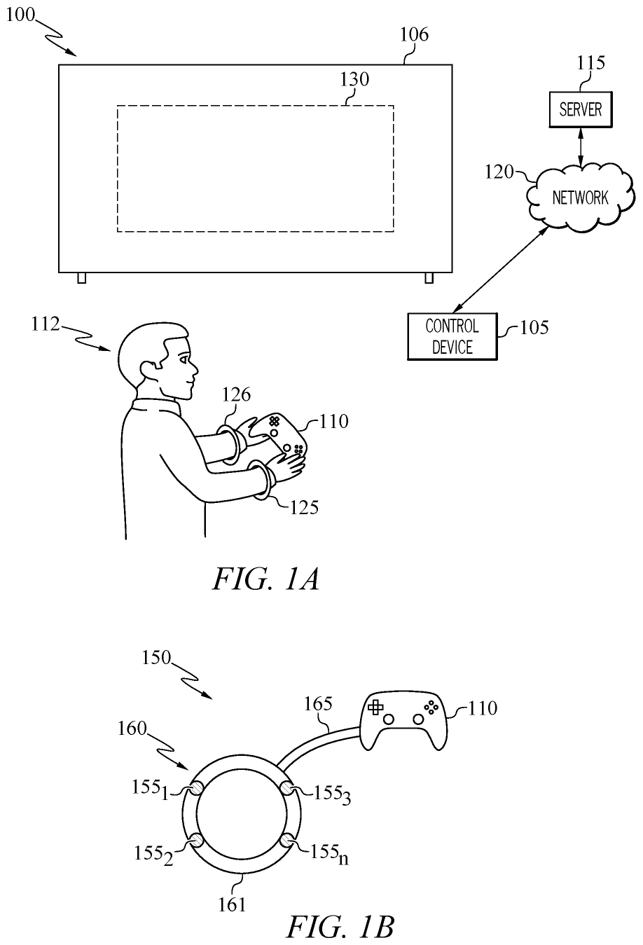

FIG. 1A is a graphical representation of a system for electronic game control with electromyography (EMG) sensing according to one or more embodiments. System 100 is configured for detecting and using one or more electromyography (EMG) sensors and operations to utilize sensor output within gaming device operations. EMG signals may be detected for a user and used for device control. System 100 may be configured for control of electronic game content and interactive entertainment including applications for virtual reality (VR) and augmented reality (AR) systems for gaming and non-gaming applications. According to embodiments, one or more devices of system 100 may be configured for electronic game control with EMG sensing and processing.

System 100 includes control device 105 which may be configured to control electronic game content presentation on display 106. Control device 105 may be a gaming device configured to output and control output of gaming content to display 106 including at least one of audio and video data. Control device 105 may be configured to receive controls for presentation of content from game controller 110. Game controller 110 may include one or more inputs for user activation or control and may be operated by a user, such as user 112. Control device 105 may communicate with at least one server, such as server 115 by way of network 120.

According to embodiments, at least one device of system 100 may be configured to use output of at least one EMG sensor for control of electronic game presentation. Detected EMG signals may be used to generate communications relative to devices. Similar to a control input communication (e.g., button press on a game controller, directional command, etc.) that is communicated to a gaming device, EMG signals may be detected and communicated in system 100. One advantage of EMG signals over game controller signals (e.g., button press) may be the time of detection and availability of detection before a game controller command is detected. Communication of EMG signals to control devices and game services can improve the latency of device operation by providing the signals to a control device before a button press or other controller command is detected.

According to embodiments, user EMG signals may be detected and monitored, with user permission, during presentation of an electronic game and interactive media in general. According to embodiments, control device 105 may relate to a media output device, such as a game console. It should be appreciated that one or more of server 115 and display device 106 may be configured to provide electronic game functions, game control and interactive media output. It should also be appreciated that detection of a user EMG signals and controller inputs is not limited to electronic games. The principles of the disclosure may be applied to other forms of network and interactive device control in general. For purposes of illustration and example of operation, system 100 and control device 105 may detect user EMG signals for users during presentation of electronic game content by display 106. Users may be controlling an electronic game output by control device 105.

According to embodiments, EMG signals may be detected from the body of a user, such as user 112, by way of at least on EMG sensor. An EMG sensor device may include a plurality of EMG sensors. For example, EMG sensor devices may include a plurality of sensors in a wearable element, such as a band or strap. According to embodiments, an EMG sensor device may be worn and/or placed on a user, such as a user's wrist, to detect electrical activity associated with user control or one or more of fingers, hands and wrists. FIG. 1A illustrates EMG sensor device 125 configured to detect EMG signals for user 112 and communicate EMG output to game controller 110. According to embodiments, controller 110 may receive EMG output from a plurality of EMG sensor devices, such as EMG sensor devices 125 and 126. EMG sensor devices 125 and 126 may each include one or more EMG sensors. According to embodiments, EMG sensor devices 125 and 126 may be electrically coupled to controller 110 and may receive power from controller 110. EMG sensor devices 125 and 126 may each include a physical element or structure, such as a strap or band, to tether to controller 110. The strap may be a textile such that EMG sensors may be provided by one or more of wires, flat electrodes, grid electrodes, and other forms of electrodes embedded in the substrate of the strap or band. EMG sensor devices 125 and 126 may be part of a wearable device, such as a smartwatch.

Processes and device configurations are described herein for detection and use of output of EMG sensor devices 125 and 126. By way of example, embodiments include controller 110 configured to receive output of at least one of EMG sensor devices 125 and 126, and detection of an EMG user control signal for user 112. The EMG user control signal may be an EMG signature, signal attribute and/or identifier indicating a user command for controller 110. For example, a user may generate electrical activity for control of the user muscles to control their movement, including wrist, hand or fingers to activate an input of a controller. One or more of EMG sensor devices 125 and 126 may detect the electrical activity prior to the actual input of a controller. According to embodiments, controller 110 may communicate the EMG signals to one or more of control device 105 and server 115 by way of network 120 for control of electronic game presentation, such as controlling gaming data generally shown as 130.

According to embodiments, system 100 may be configured for electronic game control with EMG sensing using a plurality of EMG sensors in a strap and a controller. For example, game controller 110 may be configured to interface with at least one strap including at least one electromyography (EMG) sensor. Game controller 110 may include a game controller body (e.g., housing, structure, etc.) supporting at least one input control. Game controller 110 may also include a controller (e.g., processor, etc.) housed in the game controller body electrically coupled to the at least one input control. The controller of game controller 110 is configured to receive output of at least one electromyography (EMG) sensor, such as at least one of EMG sensor devices 125 and 126, for a user of an electronic game. Output of the EMG sensor devices may include at least one EMG signal for the user. The controller of game controller 110 is also configured to detect an EMG user control signal in the at least one EMG signal for the user. The controller of game controller 110 is also configured to output the EMG user control signal for control of electronic game presentation to the gaming device. A strap configuration is discussed in FIG. 1B which may include one or more EMG sensors. Game controller 110 may interoperate with a strap configuration according to embodiments. Control device 105 may be a gaming device configured to control presentation of electronic game data including generating game data for a first game state based on the user control signal detected in the at least one EMG signal for the user. The gaming device may also be configured to generate game data for a second game state in response to the user control signal and expiration of a user controller activation window. By way of example, Control device 105 may generate or process multiple game states or functions in response to EMG data. By pre-processing or processing additional game states, control device 105 may reduce the latency of processing game data or game processing to present game content.

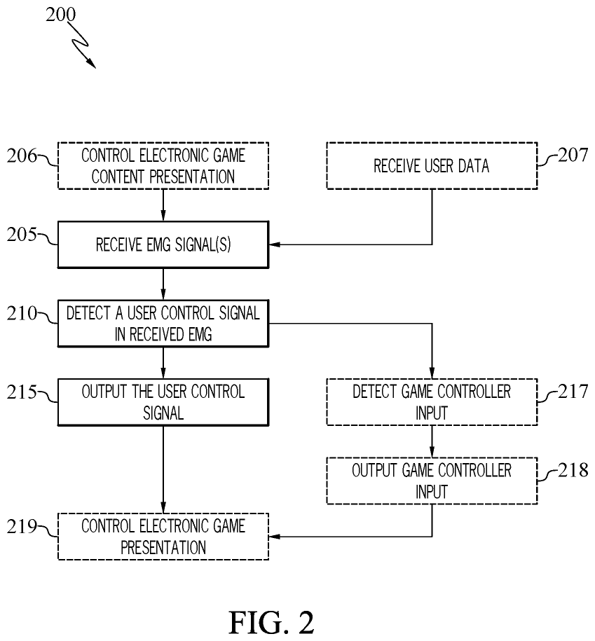

According to embodiments, control device 105 may be a standalone device, such as a game console or game media player. Control device 105 may receive user input controls and user EMG data from game controller 110. Control device 105 may communicate user input controls and user EMG data from game controller 110 to server 115 by way of network 120. According to embodiments, control device 105 and display 106 may be parts of the same unit, such as a display device with a processor or a handheld gaming device. Control device 105 may be controlled by one or more game controllers, such as game controller 110. According to embodiments, control device 105, display 106 and game controller 110 may be parts of the same unit, such as a handheld gaming device. FIG. 1A illustrates game content presentation including one or more game elements, such as game element 130. According to embodiments, control device 105 may be configured to control presentation format for the electronic game content based on at least one of user input controls and user EMG data from game controller 110. According to embodiments, user input controls and user EMG data from game controller 110 may each include signals for controlling position of a user controlled object, making a selection, or providing an input command in general. Processes for identification of EMG controls are discussed with reference to FIGS. 2 and 6. According to embodiments, system 100 may be configured to use and update machine learning models. Based on one or more user EMG signals, control device 105 may be configured to control a presentation format and the electronic game content. According to embodiments, EMG signals can be used to control operations for electronic game content presentation. According to embodiments, control device 105 may be configured to perform one or more network operations including communicating with one or more servers on a communication network. Network operations can include providing one or more EMG signals for one or more users associated with a game session.

System 100 may provide features to improve user experience, wherein functions and operations described herein are performed following user consent, with express notice to a user, and/or in alignment with one or more user settings for user privacy. By way of example, detection and/or use of EMG signals may be in response to and based on user consent. It should be appreciated that embodiments may be applied to interactive entertainment with one or more users. Processes described herein are not limited to gaming content and detection of EMG signals may be used for interactive control of gaming and non-gaming activities.

FIG. 1B is a graphical representation of a controller configuration with an EMG sensing wrist strap for electronic game control according to one or more embodiments. According to embodiments, game controller configuration 150 is provided including game controller 110 and EMG sensor device 160. Game controller configuration 150 may operate with a system, such as system 100, or one or more devices for control of electronic gaming content or interactive entertainment. EMG sensor device 160 may include one or more EMG sensors, such as EMG sensors 155₁₋ₙ. EMG sensor device 160 may be an exemplary structure of EMG sensor devices 125 and 126. EMG sensor device 160 may be electrically coupled to controller 110 and may receive power from controller 110, by way of cable 165. EMG sensor device 160 may include one or more structural elements, such as a strap or band and tether to controller 110 to secure the controller to a user.

According to embodiments, EMG sensor device 160 may include a structural element 161 supporting EMG sensors 155₁₋ₙ. Structural element 161 may be a strap, band, tether or manufactured element including at least one electromyography (EMG) sensor. Structural element 161 may include one or more elements to form a band or material for engaging with a portion of a user, such as a user's wrist. EMG sensor device 160 may be coupled to a body of game controller 110. Structural element 161 may be a strap coupled to the game controller body, the strap including at least one electrical connection for each of the EMG sensor elements and an interface of the game controller body. Cable 165 may include connections for signals and data for EMG sensors 155₁₋ₙ to connect to a controller housed in game controller 110. According to embodiments, structural unit 161 and cable 165 may be formed of one or more materials in a joint fashion, such as a strap including EMG sensors 155₁₋ₙ and electrical connections. According to embodiments, EMG sensors 155₁₋ₙ include a plurality of EMG sensor elements retained by structural element 161. The output of EMG sensors 155₁₋ₙ can include electrical activity detected from a user wrist and associated with at least one of a hand movement and finger movement of a user. The output of EMG sensors 155₁₋ₙ can include electrical activity associated with user EMG data for at least one of a button press, directional pad input, analog stick motion, finger gesture, wrist motion, and controller movement. Detecting a user control signal can include correlating at least a portion of the EMG signal to recorded EMG data for a user game controller action. Detecting a user control signal can include using a machine learning model to detect and identify the user control signal from the EMG signal.

According to embodiments, EMG sensor device 160 may be configured with EMG sensors 155₁₋ₙ built into a stretchable elastic wristband that directly plugs into a controller (e.g., a XR (AR/VR/MR) controller). EMG sensors 155₁₋ₙ may be configured to measure the electrical activity of the user's muscles in the wrist as they move their hand and fingers. The electrical signals may be converted to a digital data stream and fed to controller 110 along the attached wire that plugs into controller 110. Power for EMG sensors 155₁₋ₙ may be provided by controller 110. By controller 110 providing power, a wrist strap may be provided in a light weight and thin structure. A stretchable elastic wristband may safely secure controller 110 to a user, such that if the user accidentally loosens their grip on the controller, it will not fall and break or fly out of their hand during gameplay and cause damage. EMG sensors 155₁₋ₙ may be configured to automatically learns a user's own (potentially unique) muscle electrical activity when playing a game. The muscle signals may be indicative of one or more of button presses, including trigger and grip buttons, analog stick movement, touching and moving a finger over a touchpad, finger gestures, wrist motion and controller movement. In combination with the actual button presses, analog stick motion, touch inputs, capacitive sensing of finger gestures and six degree of freedom (e.g., 6DOF) pose from controller 110, muscle activity may be determined a period of time (e.g., 1-3 milliseconds) prior to the user's intended action. By way of example, a user pressing a button on a controller may be detected based on one or more electrical signals or pulses that travel to a user's hand (e.g., electrical pulses from a user brain). The electrical signals of the hand and finger motion may be detected in the wrist strap. EMG data may be captured in time series prior to actual detection of the game controller detecting the movement. One or more of EMG signals and controller inputs may be used to trigger a learning process.

According to embodiments, EMG sensor device 160 may include a plurality of EMG sensor elements retained by structural element 161 which may be coupled to a body of game controller 160. The structural element 161, configured as a strap or band, can include at least one electrical connection for each of the EMG sensor elements and an interface of the game controller body. Structural element 161 may include one or more fibers or elements woven or assembled to retain EMG sensors 155₁₋ₙ.

According to embodiments, the structural element 161, configured as a strap or band, can include additional sensors, such as electrocardiogram (ECG) sensors, optical reflectance photoplethysmography (PPG) sensors, or other types of sensors to measure a user's heart rate and other user biometrics like blood oxygen level. According to embodiments, the structural element 161, configured as a strap or band, can include additional elements for fitting, including hook and loop fastener sections, a clasp mechanism, or other types of adjustment mechanisms to allow the structural element 161 to be resized to fit various diameters of user wrists. Structural element 160 can perform multiple functions including at least one of hosting various sensors in close proximity to a user, and to securely fit on a user's wrist, such that cable 165 attached between the structural element 160 and game controller 110 prevents the user from dropping or throwing game controller 110. Cable 165 may be configured to provide electrical power between game controller 110 and the sensors 155₁₋ₙ, to provide data signaling between sensors 155₁₋ₙ and game controller 110, and to prevent game controller 110 from being dropped or thrown, when the user is no longer holding the controller.

According to embodiments, game controller configuration 150 is provided including game controller 110 and EMG sensor device 160. Game controller configuration 150 may operate with a system, such as system 100, or one or more devices for control of electronic gaming content or interactive entertainment. EMG sensor device 160 may include one or more EMG sensors, such as EMG sensors 155₁₋ₙ. According to embodiments, game controller configuration 150 may be configured to detect user activation of a game controller after detecting the EMG user control signal and to generate controller output based on the user activation. According to another embodiment, output of a user control signal by game controller configuration 150 can include output of the user control signal to a game controller of control device 105 prior to generating and/or outputting output of controller 110 based on the user activation. Put another way, the EMG signals may be output prior to and/or independently from actual user inputs to controller 110. Commands and input based on user activation of game controller 160 may be output to controller 110.

According to embodiments, game controller configuration 150 may be configured to detect a user control signal including correlating at least a portion of the EMG signal to recorded EMG data for a user game controller action. User EMG signals may be detected and used to train or identify a user's EMG profile for controller actions. EMG data and controller output may be mapped to identify one or more EMG profiles or signatures that correlate to actual user input controls for one or more users. According to embodiments, detection of the user control signal may include using a machine learning model to detect and identify the user control signal from the EMG signal. Game controller 110 may be configured to perform one or more operations for learning, such as self-learning, of EMG signals received from EMG sensor device 160 to determine if EMG signals indicate a controller input and if EMG signals should be communicated.

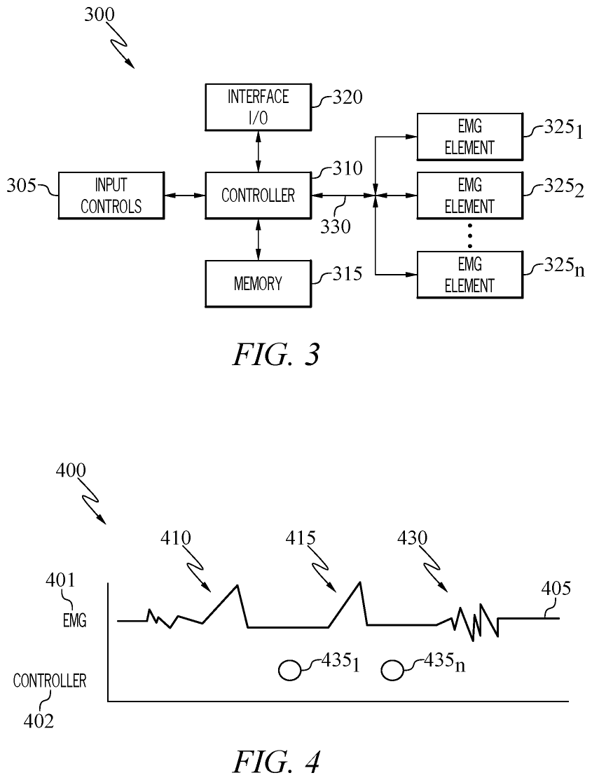

FIG. 2 illustrates a process for electronic game control with EMG sensing according to one or more embodiments. Process 200 may allow for use of EMG data detected by an EMG sensor device (e.g., EMG sensor device 160, EMG sensors 155₁₋ₙ, etc.) for electronic game control with electromyography (EMG) sensing. Process 200 may be performed by a device, such as one or more of control device 105, controller 110, server 115, device 300 and/or controller 310 of FIG. 3. Process 200 may be utilized for a system, such as the system of FIG. 1 discussed herein.

Process 200 may be initiated by a device receiving output of at least one electromyography (EMG) sensor for a user of an electronic game at block 205. According to embodiments, EMG signals received at block 205 may be detected by at least one EMG sensor of an EMG sensor device (e.g., EMG sensors 155₁₋ₙ of EMG sensor device 160). When process 200 is performed by an EMG sensor device, EMG signals may be detected at block 205. EMG signals may be detected continuously or at one or more time intervals for a user and may relate to EMG signals detected by one or more wearable or near-body sensors. The output of the at least one EMG sensor may be output by an EMG device to a game controller to provide at least one signal of electrical activity detected from a user wrist and associated with at least one of a hand movement and finger movement of a user. The output can include output of the at least one EMG sensor including electrical activity associated with user EMG data for at least one of a button press, directional pad input, analog stick motion, finger gesture, wrist motion, and controller movement.

Process 200 may optionally include controlling electronic game presentation at optional block 206. Control of an electronic game presentation can include controlling one or more game elements and game functions in response to one or more input controls, including inputs to game controller 110, shown in game controller configuration 150. Output of control signals at block 215 may be for game content presented by a control device. Electronic game control at block 206 may include control of one or more game menus, and/or control during game play. According to embodiments, process 200 may optionally include receiving user data at block 207. User data may be received to include one or more signatures or samples of user EMG data for one or more controller commands. In certain embodiments, user data received at block 207 include one or more of a user profile and user identification. Users may be identified to assist with processing of one or more user EMG signals.

At block 210, process 200 includes detecting an EMG user control signal in the at least one EMG signal for the user. Detecting a user control signal can include correlating at least a portion of the EMG signal to recorded EMG data for a user game controller action. Detection of user control signals may be based on user data for one or more game sessions and game controller actions. Control devices may be configured to detect EMG data and controller signals and correlate one or more signatures, signal profiles, samples and EMG peaks with controller actions.

At block 215, process 200 may include outputting the EMG user control signal for control of electronic game presentation. User control signals may be output to a game control device (e.g., control device 105). Output of the EMG user control signals may be output independently of user inputs to a game controller. According to embodiments, output of the EMG signals may be provided to a game controller prior to actual game controller outputs. By providing EMG signals to a control device first, and prior to output of controller inputs (e.g., button presses, directional pad inputs, analog stick inputs, etc.) a game controller may receive input commands at an earlier time. Processing abilities of a game control device may be configured to control game operations or process game functions at an earlier time. As such, game lag may be reduced by providing a means for a game controller to communicate incoming game controls. In addition, reduction of game lag may improve game performance to improve presentation speed of visible actions performed for game streaming from a cloud network and for games in virtual reality (VR) or augmented reality (AR).

Process 200 optionally includes detecting a game controller input at block 217. By way of example, an EMG signal may be detected for a button press at block 210, and the corresponding button press may be detected at block 217. Process 200 may optionally include outputting the game controller input at block 218. By way of example, the button press detected at block 217 may be output at block 218 to a game control device (e.g., control device 105).

At block 219, process 200 may optionally include controlling electronic game presentation. According to embodiments, process 200 may include detecting user activation of the game controller at block 217 after detecting the EMG user control signal at block 210 and generating controller output at block 219 based on the user activation. Outputting the user control signal at block 215 includes output of the user control signal to a game controller prior to generating the controller output based on the user activation. According to embodiments, a game controller may wait for confirmation of a game control to be received prior to controlling electronic game presentation at block 219.

Embodiments also allow for input patterns of a user to be distinguished. User EMG signals in some cases may be detected to distinguish between a half-press and a full press of an input on a game controller 110. Process 200 may reconcile one or more EMG signals, such as an EMG signal associated with a user half action or attempt to press a control button with an EMG signal for an actual button process. At block 219, process 200 may determine if a game controller output includes a corresponding match prior to controlling electronic game content presentation. Process 600 of FIG. 6 describes determining controller output based on detected EMG signals and controller input.

FIG. 3 illustrates a device configuration according to one or more embodiments. Device 300 may relate to a game controller configuration (e.g., game controller configuration 150). Device 300 may be include a game controller for electronic games or a gaming console controller. According to embodiments, device 300 may include one or more EMG sensor elements. According to embodiments, device 300 may interface with one or more EMG sensor elements. Device 300 may be configured to detect, receive and/or output one or more provide one or more EMG signals to a control device, such as a game console or network game controller. According to embodiments, device 300 includes input controls 305, controller 310, and memory 315. Device 300 may also include interface (e.g., Input output (I/O)) 320, and EMG sensor elements 325₁₋ₙ.

Controller 310 may relate to a processor or control device configured to execute one or more operations stored in memory 315, such as processes for electronic game control with electromyography (EMG) sensing and processing EMG signals of EMG elements 325₁₋ₙ. Controller 310 may be coupled to input controls 305, memory 315, interface 320, and EMG elements 325₁₋ₙ. Memory 315 may be non-transitory memory configured to provide data storage and working memory operations for device 300. Memory 315 may be configured to store computer readable instructions for execution by controller 310 for one or more processes described herein. Interface 320 may be a communications module configured to receive and transmit data relative to device 300.

EMG elements 325₁₋ₙ of device 300 may be configured to detect user signals, such as electrical currents generated in muscles and/or human tissue representing neuromuscular activities. EMG elements 325₁₋ₙ may be configured to output one or more signals of characterizing user activity and user movements, including one or more signals representing activity of a user's nervous system. EMG signals may be received and one or more control signals may be detected by controller 310 for at least one of a game controller input. Controller 310 may be configured to detect and/or communicate EMG signals to one or more devices, such as a gaming console or interactive entertainment device, for game control (e.g., control device 105). Device 300 may also include electrical coupling 330 which may include one or more cables, wires, and bus elements to provide at least one of data and power relative to controller 310 and EMG sensor elements 325₁₋ₙ. Electrical coupling 330 may be housed and/or integrated with EMG sensor structure.

According to embodiments, the EMG sensor elements 325₁₋ₙ may be configured to spatially capture surface electromyography (sEMG) signals around the circumference of a user's wrist, with monopolar or bipolar dry electrodes evenly distributed around the circumference as shown in FIG. 1B. In other embodiments, the distribution of the electrodes could be biased, such that they reside mostly next to the underside of a user's wrist.

FIG. 3 depicts a device configuration according to embodiments. Device 300 may relate to gaming controller and gaming input device in general. Device 300 may also include one or more interactive controls that communicate with a base device in general.

FIG. 4 is a graphical representation of an EMG signal and controller input in time series according to one or more embodiments. According to embodiment, at least one of game controller (e.g., game controller 110) inputs and EMG sensor output (e.g., EMG sensors 155₁₋ₙ) may be used to control electronic game presentation. Control data 400 includes EMG signal data 401 and controller input data 402. EMG signal data 401 may relate to output of one or more EMG sensors (e.g., EMG sensors 155₁₋ₙ) detected for a user during electronic gameplay. Controller input data 402 represents game inputs to a game controller (e.g., game controller 110). Users may hold a game controller and activate the game controller through one or more of controller movement, activation of controller inputs (e.g., directional pad movement, button press, analog stick motion, surface commands, taps, slides, etc.). A user may not be aware or feel internal electrical signals sent from a user's brain to user muscles to activate a controller. According to embodiments, one or more EMG sensors may be worn or placed in proximity to one or more portions of a user's body to detect electrical stimuli for muscle control including EMG signals of a user in connection a with controller activation. EMG data 401 includes detected EMG signal 405 including peaks 410, 415 and signal profile 430. Peaks 410 and 415 may be indicative of a user EMG signal to activate a game controller, such as a button press. Peaks 410 and 415 may be indicative of muscle tightening that is detected to read prior to control inputs, such as 5 ms-150 ms delay between EMG signal and controller input. It should be appreciated that peaks 410 and 415 are exemplary and that user EMG control signals may include one or more of an EMG peak, time signature, and signal pattern. It should be noted, that based on numerous medical studies, neuro-electrical signals from the brain to instigate finger motion have been measured to take between 3-4 ms (milliseconds) from the wrist area to digit motion. The time period from the wrist area to digit motion may be a minimal latency reference for the onset of finger motion. This latency period does not include the time for finger travel, as well any controller button or other controller sensor physical travel/delay before an electrical signal is generated from the sensed controller input. Therefore, wrist-to-controller input latencies can be from 5 ms or typically more depending on the user, the controller input and it's physical travel/delay before signal generation. It should be understood, that determining controller inputs via an EMG sensing wrist strap at least 5 ms before an actual controller input is detected can greatly contribute to the reduction in overall latency for the inputs to a gaming system, especially a network streaming based gaming system.

According to embodiments, peaks 410 and 415 may be detected and correlated to user game controls. One or more processes including machine learning processes may be used to identify EMG user control signals such as peaks 410 and 415 relating to a user control. Controller data 402 includes detection of a controller actions 435₁₋ₙ which correspond to peaks 410 and 415. According to embodiments, when an EMG signal or signal profile is detected of an action that precedes a controller command or is indicative of a controller command, such as peaks 410 and 415 preceding controller commands 435₁₋ₙ, a control device may communicate the detection of the EMG user control signals to one or more devices for controlling presentation of gaming content. According to embodiments, communication of an EMG user control signals for detected peaks 410 and/or 415 may be output prior to detection of controller data 402. According to embodiments, EMG data 401 may be filtered to remove EMG signals not indicative of a game controller signal. Embodiments can include filtering of EMG data, such as signal profile 430.

According to embodiments, a machine learning process, for example a supervised reinforcement learning process, may utilize one or more channels of EMG user control signal data withing a sampling time window to filter and correlate characteristics around signal peaks associated with finger, palm, and wrist muscle activity. For example, peaks 410 and 415 may contain uniquely identifiable characteristics before and after their peak signal, including a typical range of rising slope lengths, as the number of rising signal values from a low threshold value to the peak value and/or a typical range of falling slope lengths, as the number of falling signal values from the peak value to a low threshold value.

According to embodiments, EMG data 401 may include one or more detected EMG signals, such as EMG signal 405, as input for machine learning operations. The machine learning operations may include statistical or recursive operations to correlate one or more previous EMG time series or data prior to a button press. From detecting repeated actions of a user, such as a user pressing the same button, a signal filter can be derived to isolate the specific EMG signal spikes that correlate to the user's finger pressing the button. After one or more training sessions, which may be performed in the background while a user plays a game (e.g., no specific training period allocated required), a filter may be used to detect user input, such as a user's finger button pushing intent a few milliseconds before a button is pressed. Once this intent is recognized, the action for the button is sent to the server running the game, to prepare the result of the action sooner than before. Using the above processing, a controller with EMG sensors or a wrist strap can learn to reduce the latency of user inputs over time and help a game streaming over a network appear to reduce the latency of user's actions within a game, such that it appears the game is running locally on a console or PC within the home. It should be understood, that a general model (e.g., a collection of previously learned EMG signals to user input filters) may be created ahead of time and available in the system to all players, so that streaming games appear to have lower latency immediately. It should be also understood, that each user's EMG signals and the way they wear the wrist strip, will be different, so the general model will only provide a baseline solution. As each user plays games, the general model learns to become a personalized EMG signal to intent model and that is stored with the user's login data, such that it is retrieved every time the user logs into the system to play games. In addition, all personalized EMG signals to user intent models from many users can be collated and a better general model can be derived. With the above described system, the average input latencies within streaming games will gradually reduce as many users play games.

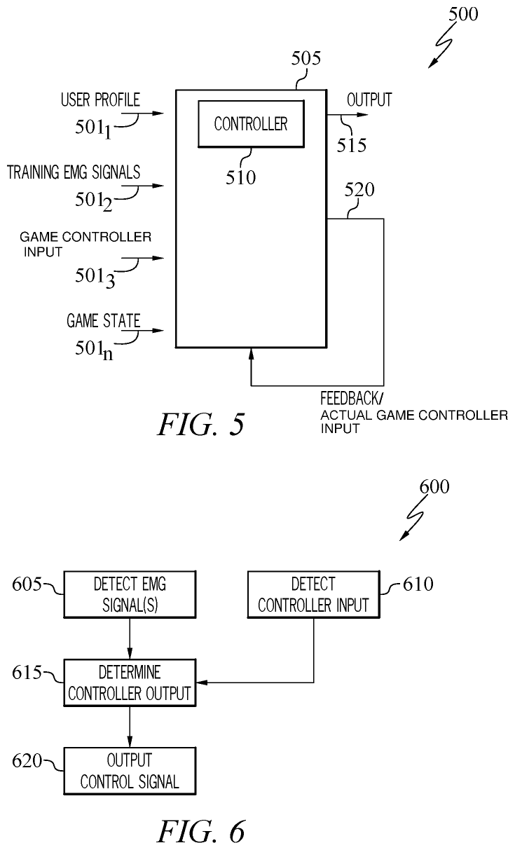

FIG. 5 is a graphical representation of machine learning operations according to one or more embodiments. Process 500 may be performed for training a model for electronic game control with EMG signals according to one or more embodiments. Training process 500 can include receiving training parameters 501₁₋ₙ as training input by a device 505 including a controller 510. According to embodiments, controller 510 may receive a plurality of forms of player input controls and EMG samples as training input. In embodiments, training parameters 501₁₋ₙ may include data for user profile 501₁, training EMG signals 501₂, game type/genre 501₃, and game state 501ₙ. User profile 501₁ may provide one or more parameters characterizing a user including user profile entries, and controller type. User profile 501₁ may include one or more signal profiles of user EMG data. Training EMG signals 501₂ may provide examples of EMG signals and identifying one or more corresponding controller input commands. Game controller input 501₃ may provide training data regarding commands for a game and EMG signals to game controls including actual player input by way of a game controller sensor inputs. Player input controls may be labeled as examples of user actions for gaming content. Game state 501ₙ may relate to one or more parameters or frameworks for permissible game options. Game state 501ₙ may include one or more parameters for a game type/genre. Based on the training in process 500, controller 510 may generate output 515. Output 515 may include one or more game control parameters for controlling a game session. According to embodiments, controller 510 may be configured to generate output 515 based on a recursive loop including training and feedback. Feedback loop 520 may provide information such as adjustments to the machine learned process within controller 510, ratings, and accuracy for output 515. Feedback loop 520 may feedback the ground truth data on actual player inputs to a game controller.

According to embodiments, training process 500 and controller 510 may be configured to use one or more learning models (e.g., artificial intelligence, iterative models, etc.) to detect and evaluate EMG signals associated with finger, palm, wrist and hand motion data. Training process 500 and controller 510 may use one or more libraries of player inputs and EMG signals as control examples. According to embodiments, output 515 may include output of control signals identifying one or more of EMG signals and game controller actions.

According to embodiments, training process 500 may use a model for human EMG signals and controller functions. The model may also account for user movement patterns. By detecting muscle activation signals in EMG signals, user intentions for control commands may be isolated and separated. A general model may be trained and used to detect one or more of hand gestures, speed of input, and reaction time using EMG data. User movements may be detected for user signs, such as a peace symbol or hand gestures of closed first to thumbs up. Timing of a thumb going up and capacitance of lowering of a user finger to a capacitive sensor of a game controller may be used for multi-sensor data in case gesture detection is needed. EMG signal detection may be predictive, such that the detection window of input commands may be shifted to allow for earlier indications of user actions.

FIG. 6 illustrates a process for game controller operations according to one or more embodiments. Process 600 may be initiated by detecting at least one EMG signal at block 605. EMG signals for a user may be detected by one or more EMG sensor devices worn and/or used by a user. Process 600 may include detection of controller input, such as one or more user actions and/or inputs to a game controller. EMG signals detected at block 605 and controller input detected at block 610 may be detected independently. According to embodiments, game control operations may be improved using EMG data and determinations of controller output.

At block 615, process 600 may determine a controller output based on at least one of detected EMG signals at block 605 and detected controller input at block 610. When EMG data is detected at block 605, the EMG signals may be a preview of one or more actions a user is expected to make, such as a controller input. Detection of the EMG signals may provide user intentions in advance of detected controller input. When EMG data is not available a controller output may be determined based on controller input. Determining controller output can include determining EMG signal elements to communicate to a game controller. Determination of controller output at block 615 may be performed to detect one or more button misfires. By way of example, user desire detected based on EMG signals for a button press activation or controller input in general may activate an incorrect button resulting in game play stopping or activation of a menu. According to embodiments, the EMG signal may override a button misfire to present or control game content based on the EMG signal. According to embodiments, determining controller output at block 615 may be based on a game state.

According to embodiments, process 600 may provide self-learning operations to refine and improve characterization of detected EMG signals. Operations at block 615 may characterize and refine EMG signal characteristics indicative of control signal input. By way of example, determining controller output may including determining a thumb or a trigger finger input and thumb press compared to one or more joystick controls. EMG and controller input data may be processed in parallel in process 600.

According to embodiments, process 600 may reduce impulse expression by using EMG data and controller data. In embodiments, EMG signals may be used as an initial identification and controller input may be used as verification. False positives for buttons recognitions may also be reduced. A system may cancel online activity for content that is not provided on other devices, such as a rollback of game object activity. For some applications, such as HMD (head mounted devices), multiple outcomes may be generated to take advantage or one or more intervals where content is not presented to a user. For example, two or more outcome may be generated for presentation and one of the outcomes may be selected in response to controller input. Therefore, in such a system the EMG signal could be used to prepare outcomes to be ready for presentation before determining the confirmation of the outcome by utilizing the later controller input.

At block 620, process 600 includes outputting a control signal. Control signal output may include output of EMG signal data and/or control signals based on detected controller input detected at block 610. Unlike a conventional controller only outputting data from detected controller inputs, EMG data may be output independently or in conjunction with detected controller input.

While this disclosure has been particularly shown and described with references to exemplary embodiments thereof, it will be understood by those skilled in the art that various changes in form and details may be made therein without departing from the scope of the claimed embodiments.

What is claimed is:

1. A method for electronic game control with electromyography (EMG) sensing, the method comprising:
receiving, by a device, output of at least one electromyography (EMG) sensor for a user of an electronic game, the output including at least one EMG signal for the user;
detecting, by the device, an EMG user control signal in the at least one EMG signal for the user; and
outputting, by the device, the EMG user control signal for control of electronic game presentation.

2. The method of claim 1, wherein the output of the at least one EMG sensor includes electrical activity detected from a user wrist and associated with at least one of a hand movement and finger movement of a user.

3. The method of claim 1, wherein the output of the at least one EMG sensor includes electrical activity associated with user EMG data for at least one of a button press, directional pad input, analog stick motion, finger gesture, wrist motion, and controller movement.

4. The method of claim 1, wherein detecting a user control signal includes correlating at least a portion of the EMG signal to recorded EMG data for a user game controller action.

5. The method of claim 1, further comprising detecting user activation of the game controller after detecting the EMG user control signal and generating controller output based on the user activation, and wherein outputting the user control signal includes output of the user control signal to a game controller prior to generating the controller output based on the user activation.

6. A game controller comprising:
a strap including at least one electromyography (EMG) sensor;
a game controller body supporting at least one input control; and
a controller housed in the game controller body electrically coupled to the at least one input control, wherein the controller is configured to
receive output of at least one electromyography (EMG) sensor for a user of an electronic game, the output including at least one EMG signal for the user;
detect an EMG user control signal in the at least one EMG signal for the user; and
output the EMG user control signal for control of electronic game presentation.

7. The game controller of claim 6, wherein the at least one EMG sensor includes a plurality of EMG sensor elements retained by the strap, wherein the strap is coupled to the game controller body and configured to secure the game controller to the user, and wherein the strap includes at least one electrical connection for each of the EMG sensor elements and an interface of the game controller body.

8. The game controller of claim 6, wherein the output of the at least one EMG sensor includes electrical activity detected from a user wrist and associated with at least one of a hand movement and finger movement of a user.

9. The game controller of claim 6, wherein the output of the at least one EMG sensor includes electrical activity associated with user EMG data for at least one of a button press, directional pad input, analog stick motion, finger gesture, wrist motion, and controller movement.

10. The game controller of claim 6, wherein detecting a user control signal includes correlating at least a portion of the EMG signal to recorded EMG data for a user game controller action.

11. The game controller of claim 6, wherein detecting a user control signal includes using a machine learning model to detect and identify the user control signal from the EMG signal.

12. The game controller of claim 6, further comprising detecting user activation of the game controller after detecting the EMG user control signal and generating controller output based on the user activation, and wherein outputting the user control signal includes output of the user control signal to a game controller prior to generating the controller output based on the user activation.

13. A system comprising:
a gaming device; and
a game controller,
a strap including at least one electromyography (EMG) sensor;
a game controller body supporting at least one input control; and
a controller housed in the game controller body electrically coupled to the at least one input control, wherein the controller is configured to
receive output of at least one electromyography (EMG) sensor for a user of an electronic game, the output including at least one EMG signal for the user;
detect an EMG user control signal in the at least one EMG signal for the user; and
output the EMG user control signal for control of electronic game presentation to the gaming device.

14. The system of claim 13, wherein the at least one EMG sensor includes a plurality of EMG sensor elements retained by the strap, wherein the strap is coupled to the game controller body and configured to secure the game controller to the user, and wherein the strap includes at least one electrical connection for each of the EMG sensor elements and an interface of the game controller body.

15. The system of claim 13, wherein the output of the at least one EMG sensor includes electrical activity detected from a user wrist and associated with at least one of a hand movement and finger movement of a user.

16. The system of claim 13, wherein the output of the at least one EMG sensor includes electrical activity associated with user EMG data for at least one of a button press, directional pad input, analog stick motion, finger gesture, wrist motion, and controller movement.

17. The system of claim 13, wherein detecting a user control signal includes correlating at least a portion of the EMG signal to recorded EMG data for a user game controller action.

18. The system of claim 13, wherein detecting a user control signal includes using a machine learning model to detect and identify the user control signal from the EMG signal.

19. The system of claim 13, further comprising detecting user activation of the game controller after detecting the EMG user control signal and generating controller output based on the user activation, and wherein outputting the user control signal includes output of the user control signal to a game controller prior to generating the controller output based on the user activation.

20. The system of claim 13, wherein the gaming device is configured to control presentation of electronic game data, and wherein the gaming device is configured to generate game data for a first game state based on the user control signal detected in the at least one EMG signal for the user, and wherein the gaming device is configured to generate game data for a second game state in response to the user control signal and expiration of a user controller activation window.
